(19) United States
(12) Patent Application Publication
(10) Pub. No.: US 2009/0079699 A1
(43) Pub. Date: Mar. 26, 2009

(54) METHOD AND DEVICE FOR ASSOCIATING OBJECTS

(75) Inventor: JIAN SUN, SINGAPORE (SG)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/859,915

(22) Filed: Sep. 24, 2007

(51) Int. Cl. G06F 3/041

(52) U.S. Cl. 345/173

(57) ABSTRACT

A method (400) of associating objects in an electronic device (100), the method (400) performs identifying a first object (420) in response to detecting an initial contact of a scribed stroke (410) at a location of a first area of a touch sensitive user interface (170) which corresponds with the first object. Next there is performed identifying a second object (455) in response to detecting a final contact (450) of the scribed stroke at a location of a second area of the touch sensitive user interface (170) which corresponds with the second object. Then the method (400) performs associating the first object with the second object (460) and wherein one of the first and second areas of the touch sensitive user interface (170) is a touch sensitive display screen (105) and the other area of the touch sensitive user interface (170) is a touch sensitive keypad (165).

### FIELD OF THE INVENTION

The present invention relates generally to the field of user interfaces and user control of an electronic device.

### BACKGROUND OF THE INVENTION

Portable handheld electronic devices such as handheld wireless communications devices (e.g. cellphones) and personal digital assistants (PDA's) that are easy to transport are becoming commonplace. Such handheld electronic devices come in a variety of different form factors and support many features and functions.

A problem with such devices is the restriction on user interfaces given their small size. For example keypads with a limited number of keys, display screens with a limited number of icons compared with personal computers with a full keyboard and a large screen with sophisticated graphical user interfaces including the use of a mouse. As small electronic devices become more powerful there is a desire to perform more complicated tasks however this is restricted by the limited nature of their user interfaces. Typically complicated tasks involving multiple applications must be performed using numerous menu driven operations that are time consuming and inconvenient for users.

Various efforts have been made to improve user interfaces on small portable electronics devices, including the use of touch sensitive display screens which allow a user to employ a soft keyboard for example, or actuate an application icon using contact with the display screen. In alternative arrangements, a touch sensitive keypad may be used to receive scribed strokes of a user's finger in order to input data such as scribed letters which can then be displayed on a non-touch sensitive screen. In yet further alternative arrangement, a full QWERTY keyboard may be temporarily connected to the electronic device for data entry or other user interface intensive tasks.

### BRIEF DESCRIPTION OF THE DRAWINGS

In order that the invention may be readily understood and put into practical effect, reference will now be made to an exemplary embodiment as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic block diagram illustrating circuitry of an electronic device in accordance with the invention;

FIGS. 2A and 2B illustrate an electronic device comprising a touch sensitive keypad integrated into an array of user actuable input keys in exploded perspective and section views respectively;

FIGS. 3A and 3B illustrate operation of an electronic device touch sensitive display screen and touch sensitive keypad according to an embodiment;

FIG. 4 illustrates a flow chart for an algorithm according to an embodiment; and

FIG. 5 illustrates a flow chart for an algorithm according to another embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

In general terms in one aspect there is provided a method of associating objects in an electronic device, and comprising identifying a first object in response to detecting an initial contact of a scribed stroke at a location of a first area of a touch sensitive user interface which corresponds with the first object, identifying a second object in response to detecting a final contact of the scribed stroke at a location of a second area of the touch sensitive user interface which corresponds with the second object, associating the first object with the second object. One of the first and second areas of the touch sensitive user interface is a touch sensitive display screen and the other area of the touch sensitive user interface is a touch sensitive keypad.

An object refers to an entity that represents some underlying data, state, function, operation or application. For example one of the objects may be data such as an email address from a contacts database, and the other object may be a temporary storage location or another application such as an email client. Associating one object with another refers to copying or moving the contents of one object to another and/or executing one of the objects using the contents of the other object; or to linking the first object to the second object for example as a short-cut key to an application. In another example, an email client (one object) may be executed and open a new email using the email address from the other object (a contact), or the contents of one object (eg email address from contacts database) may be copied into a temporary storage location (the other object). This enables drag-and-drop operations to be carried out on a small electronics device. Whilst examples of objects and associations have been given above, the skilled person will recognise that these terms are not so limited and will be familiar with other examples of computing objects and associations.

In an embodiment, the first area of the touch sensitive user interface is the touch sensitive display screen, and the second area (or other area) is the touch sensitive keypad. In such an embodiment, a user may drag-and-drop an email address from a contacts database open on the display screen to a temporary storage location associated with a key on the touch sensitive keypad. By touching the email address, and dragging this over the screen to the appropriate key of the touch sensitive keypad, the email address is stored and may be retrieved later; for example to copy into another application such as an email client newly displayed on the display screen. In an alternative embodiment, the first area of the touch sensitive user interface is the touch sensitive keypad, and the second area (or other area) is the touch sensitive display screen.

Before describing in detail embodiments that are in accordance with the present invention, it should be observed that the embodiments reside primarily in combinations of method steps and device components related to associating objects in an electronic device. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the method, or device that comprises the element. Also, throughout this specification the term “key” has the broad meaning of any key, button or actuator having a dedicated, variable or programmable function that is actuatable by a user.

It will be appreciated that embodiments of the invention described herein may be comprised of one or more conventional processors and unique stored program instructions that control the one or more processors to implement, in conjunction with certain non-processor circuits, some, most, or all of the functions of associating objects in an electronic device described herein. The non-processor circuits may include, but are not limited to, a radio receiver, a radio transmitter, signal drivers, clock circuits, power source circuits, and user input devices. As such, these functions may be interpreted as steps of a method to perform user function activation on an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

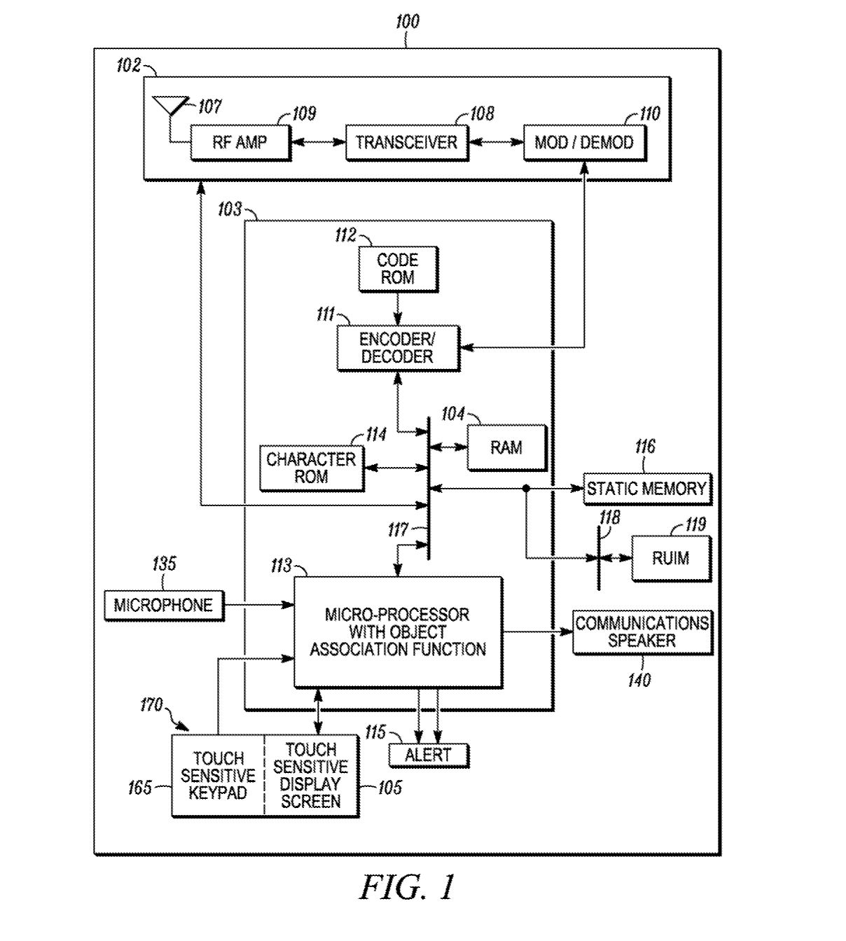

Referring to FIG. 1, there is a schematic diagram illustrating an electronic device 100, typically a wireless communications device, in the form of a mobile station or mobile telephone comprising a radio frequency communications unit 102 coupled to be in communication with a processor 103. The electronic device 100 also has a touch sensitive user interface 170. In this embodiment, the first area of the touch sensitive user interface comprises a touch sensitive display screen 105, the second area (or other area) of the touch sensitive user interface comprises a touch sensitive keypad 165. However, the first area of the touch sensitive user interface can be the touch sensitive keypad 165 and the second area (or other area) of the touch sensitive user interface can the touch sensitive display screen 105. There is also an alert module 115 that typically contains an alert speaker, vibrator motor and associated drivers. The touch sensitive display screen 105, touch sensitive keypad 165 and alert module 115 are coupled to be in communication with the processor 103. Typically the touch sensitive display screen 105 and the touch sensitive keypad 165 of the touch sensitive user interface 170 will be located adjacent each other in order to facilitate user operation.

The processor 103 includes an encoder/decoder 111 with an associated code Read Only Memory (ROM) 112 for storing data for encoding and decoding voice or other signals that may be transmitted or received by the electronic device 100. The processor 103 also includes a micro-processor with object association function 113 coupled, by a common data and address bus 117, to the encoder/decoder 111, a character Read Only Memory (ROM) 114, radio frequency communications unit 102, a Random Access Memory (RAM) 104, static programmable memory 116 and a Removable User Identity Module (RUIM) interface 118. The static programmable memory 116 and a RUIM card 119 (commonly referred to as a Subscriber Identity Module (SIM) card) operatively coupled to the RUIM interface 118 each can store, amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. The RUIM card 119 and static memory 116 may also store passwords for allowing accessibility to password-protected functions on the electronic device 100.

The micro-processor with object association function 113 has ports for coupling to the display screen 105, the keypad, the alert module 115, microphone 135 and a communications speaker 140 that are integral with the device.

The character Read Only Memory 114 stores code for decoding or encoding text messages that may be received by the radio frequency communications unit 102. In this embodiment the character Read Only Memory 114, RUIM card 119, and static memory 116 may also store Operating Code (OC) for the micro-processor with object association function 113 and code for performing functions associated with the electronic device 100.

The radio frequency communications unit 102 is a combined receiver and transmitter having a common antenna 107. The radio frequency communications unit 102 has a transceiver 108 coupled to the antenna 107 via a radio frequency amplifier 109. The transceiver 108 is also coupled to a combined modulator/demodulator 110 that couples the radio frequency communications unit 102 to the processor 103.

The touch sensitive user interface 170 detects manual contact from a user's finger or stylus on either or both of the display screen 105 and the keypad 165. The detected manual contacts are interpreted by the processor 103 as points or lines of contact or touch across an xy co-ordinate system of the first (105) and second (165) area of the touch sensitive user interface 170. The interpretation of the detected manual contacts as points or lines of contact by the processor 103 will typically be implemented with the execution of program code as will be appreciated by those skilled in the art. In alternative embodiments, this function may be achieved using an ASIC or equivalent hardware.

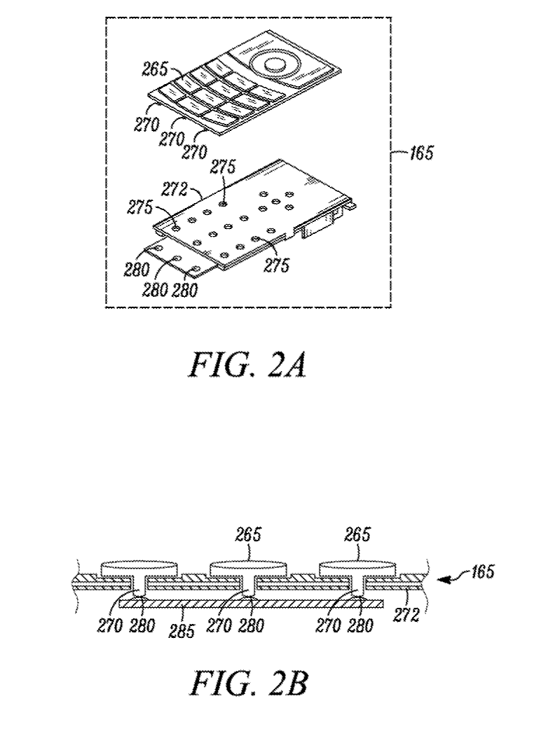

FIGS. 2A and 2B illustrate in more detail an example touch sensitive keypad arrangement. Touch sensitive display screens 105 will be well known to those skilled in the art and is not further described here. The touch sensitive keypad 165 comprises a number of user input keys 265 which are integrated in an overlaying relation with capacitive sensor array 272 that which detects changes in capacitance corresponding to the presence of a user's digit or other object such as a stylus. The touch sensitive keypad 165 or second area of the touch sensitive user interface 170 allows for receiving user contact, touch points or lines of contact with the keypad 165. Detection of a finger or stylus does not require pressure against the capacitive sensor array 272 or user input keys 265, but typically just a light touch or contact against the surface of the keypad 165; or even just close proximity. It is therefore possible to integrate the user input keys 265 and the capacitive sensor array 272, as the keys 265 require physical pressure or a tactile force for actuation whereas the capacitive sensors of the capacitive sensor array 272 do not. Thus it is possible to detect manual contact at the keypad 165 without actuating any of the user input keys 265. An example of a touch sensitive keypad 165 is the finger writing recognition tablet on the A668 mobile phone available from Motorola Incorporated. AS shown, the user input keys 265 each have a plunger that passes through apertures 275 in the capacitive sensor array 272 and contact respective dome switches 280 on a switch substrate 285.

Whilst capacitive sensors are typically used, other sensor arrays may alternatively be used such as ultrasound sensors to detect the user input object's position. Similarly the “activation” of a sensor may be configured to correspond to contact between a user input object such as a finger and the surface of the tablet, or even close proximity of the distal end of a user input object with the sensor such that actual physical contact with the tablet surface may not be required.

The changes in capacitance detected at the capacitive sensor array 272 are translated into a contact location on an xy grid by the processor 103. Alternatively the points or strokes of contact may be captured by an ink trajectory processor as ink trajectories with respect to the co-ordinate system of the touch sensitive keypad 165. These inks or manual contact locations are then forwarded to the processor 103 and interpreted as manual contact locations for further processing as described in more detail below. A suitable ink trajectory processor may be that used in the Motorola™ A688 mobile phone.

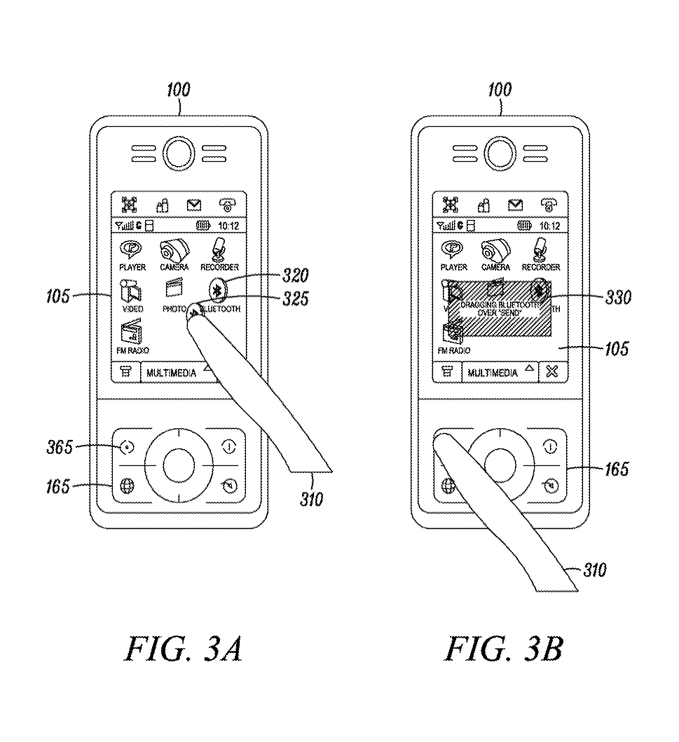

FIGS. 3A and 3B illustrate an electronic device 100 which comprises a touch sensitive display screen 105 and a touch sensitive keypad 165 having a number of user actuable keys for entering user data and controls. The keypad 165 includes a send key (top left) 365 for sending messages or as a call key for voice communication, and a close key (top right) which can be used to close applications and terminate a voice call. The display screen 105 includes a number of icons 320 corresponding to various applications or functions that the user of the electronic device 100 may use.

Together, FIGS. 3A and 3B also illustrate a method of using the electronic device 100 (typically a mobile phone). A user's finger 310 can be used to drag an icon from the touch sensitive display screen 105 to the touch sensitive keypad 165. In this example, the icon is associated with a Bluetooth™ application or first object. Movement of the (Bluetooth™) icon 320 across the touch sensitive display screen 105 is indicated by the partially drawn icon 325 which corresponds with the point of contact of the finger 310 across the display screen 105. The user's finger 310 moves from the touch sensitive display screen 105 to the touch sensitive keypad 165 as shown in FIG. 3B. Here the user's finger 310 is touching the send key 365. The send key 365 in this example is associated with a storage location or second object. By dragging the icon 320 to the send key 365, the Bluetooth™ application or first object is associated with the storage location or second object. In order to identify the first object, the initial contact of a scribed stroke or user “drag” operation is detected which corresponds to the location of an icon 320 on the touch sensitive display screen 105. In order to identify the second object with which to associate the first object, a final contact of the scribed stroke or a user “drop” operation is detected which corresponds to the location of a key 365 on the touch sensitive keypad 165.

The final contact corresponds the lifting off of the user's finger 310 from the keypad 165. Thus a first object (Bluetooth™ application) is associated (shortcut link) to a second object (storage location). This shortcut to the Bluetooth™ application may then be used subsequently, for example when a different application is open or displayed on the display screen 105. When a user has completed an email the Bluetooth™ application may be dragged from the send key over to the email causing the email to be sent via Bluetooth™.

In an alternative embodiment, the step of associating one object with another might be achieved by actuating a key (365) on the keypad 165 instead of simply terminating contact by lifting the user's finger 310 from the keypad 165. This means that in some embodiments, a touch sensitive keypad 165 may not be needed, and instead the icon 325 may be dragged across to the edge of the touch sensitive screen 105 and then a key 265 may be actuated to associate the object represented by the icon (Bluetooth™ application) with the object represented by the actuated key (storage location).

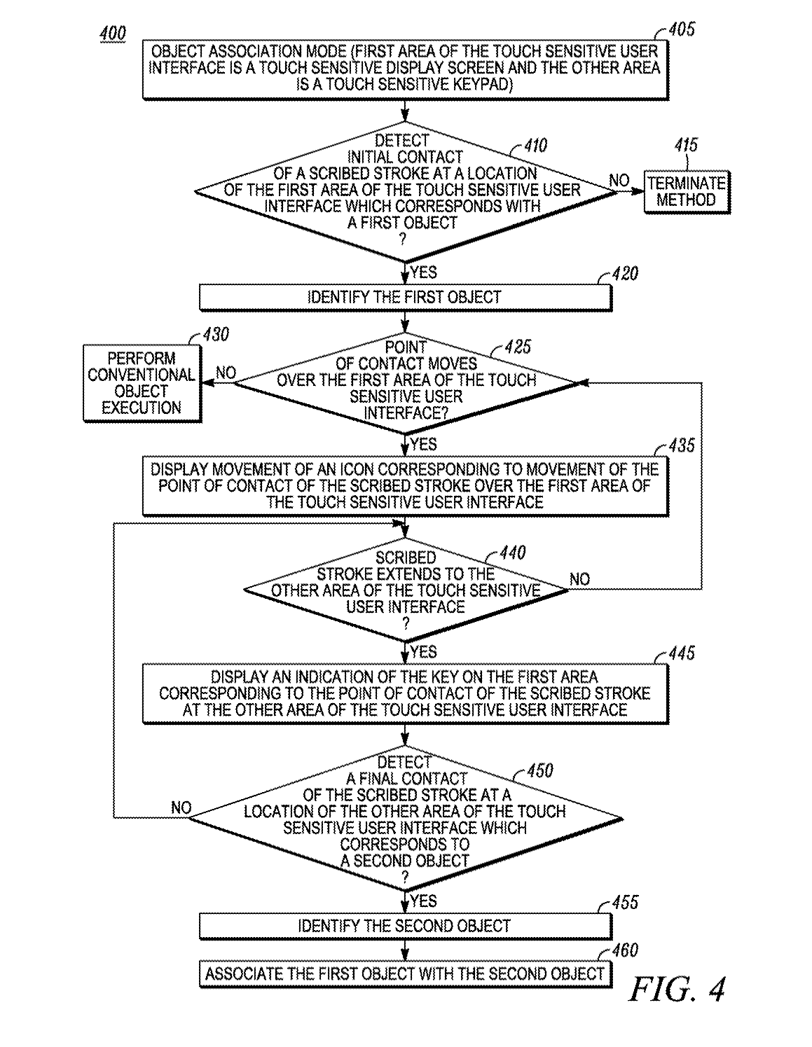

FIG. 4 illustrates in more detail a method of associating objects in an electronic device 100. This method 400 will typically be implemented by executing a software program from the static memory 116 on the microprocessor with object association function 113 which receives inputs from the touch sensitive user interface 170. The method 400 is activated on the electronic device 100 by the user selecting an object association mode at step 405, for example by selecting a menu option. The method then monitors the first area of the touch sensitive user interface or touch sensitive display screen 105 in this embodiment in order to detect an initial contact of a scribed stroke at a location corresponding to a first object at step 410. The scribed stroke corresponds to the movement of the point of contact of a user's finger 310 or stylus across the first and second areas of the touch sensitive user interface 105 and 165. The location corresponding to the first object may be indicated by an icon 320 as previously described; for example the Bluetooth™ application icon of FIG. 3A.

If no initial contact is detected (410N), for example after a predetermined time, then the method terminates at step 415. If however an initial contact is detected (410Y), then in response the first object (Bluetooth™ application) is identified according to the location of the detected initial contact at step 420. For example if the initial contact is at the location of the Bluetooth™ icon 320, then the Bluetooth™ application is identified as the first object. The method 400 then determines whether the point of contact moves over the first area of the touch sensitive user interface at step 425. If not (425N), this means there is no scribed stroke, and in fact there is only stationary or temporary contact and the method then performs conventional object execution at step 430. For example if the Bluetooth™ icon 320 is merely touched by the user's finger 310, then the Bluetooth™ application is launched or executed and the method then terminates. If however the point of contact moves (425Y), then the method displays on the touch sensitive screen movement of the icon 320 corresponding to or following movement of the point of contact of the scribed stroke over the display screen 105 at step 435. This movement of the icon was shown in FIG. 3A by the partially drawn icon 325 following the user's finger across the display screen 105.

The method 400 then determines whether the scribed stroke or point of contact extends or moves to the other area of the touch sensitive user interface or touch sensitive keypad 165 in this embodiment at step 440. This may be implemented by detecting touch at any location on the keypad 165. If the scribed stroke doesn't extend onto the touch sensitive keypad 165 (440N), then the method returns to the step of determining whether movement of the point of contact or the scribed stroke moves over the touch sensitive display screen 105 at step 425. If however the scribed stroke does extend onto the touch sensitive keypad 165 (440N), then the method displays on the display screen 105 an indication of the key 265, 365 on the touch sensitive keypad 165 corresponding to the point of contact of the scribed stroke at step 445. An example indication 330 is shown in FIG. 3B which displays both a label for the first object, in this case Bluetooth™, together with a label for the key, in this case “Send”. Alternative indications may be used, for example simply displaying the symbol printed on the key 265 which is currently being touched by the user.

The method 400 then monitors the second area of the touch sensitive user interface or keypad 165 to detect a final contact of the scribed stroke at a location corresponding to a second object at step 450. Detecting a final contact may comprise detecting lift off of the finger 310 or stylus from the keypad 165, and if this is at a key 265 which is associated with a second object (450Y), then in response the method identifies the second object at step 455. The second object (eg temporary storage location) is identified according to the location of the detected final contact (eg send key). If however a final contact is not detected after a predetermined time or a final contact is detected which does not correspond with a second object (450N), for example the final contact is between keys or is over a key not assigned to a second object, then the method 400 returns to determine whether the scribed stroke still extends over the second area of the touch sensitive user interface at step 440. Whilst locations of the second area of the touch sensitive user interface 170 which correspond to a second object have been described as also corresponding to keys 265, 365, this need not be the case. For example, the second objects may be assigned simply to xy coordinates on the keypad 165 and can be identified solely using the indication 330 in the display screen 105.

In an alternative embodiment using a non touch sensitive keypad, the method identifies the second object in response to detecting actuation of a key on the keypad which corresponds with the second object. In this case, actuation of the key follows termination of the scribed stroke on the touch sensitive display screen.

Once a second object has been identified at step 455, the method associates the first and second objects at step 460. As described previously, association of two objects can cover a variety of actions including moving or copying content from one object to another, storing the content of the first object (in the second object—a temporary storage location), or providing a shortcut or other link from one object to another. Where one of the objects is an application, this application may be automatically executed upon associating the first and second objects. For example a Bluetooth™ object may be started when associated with an email object in order to send the email over a Bluetooth™ connection.

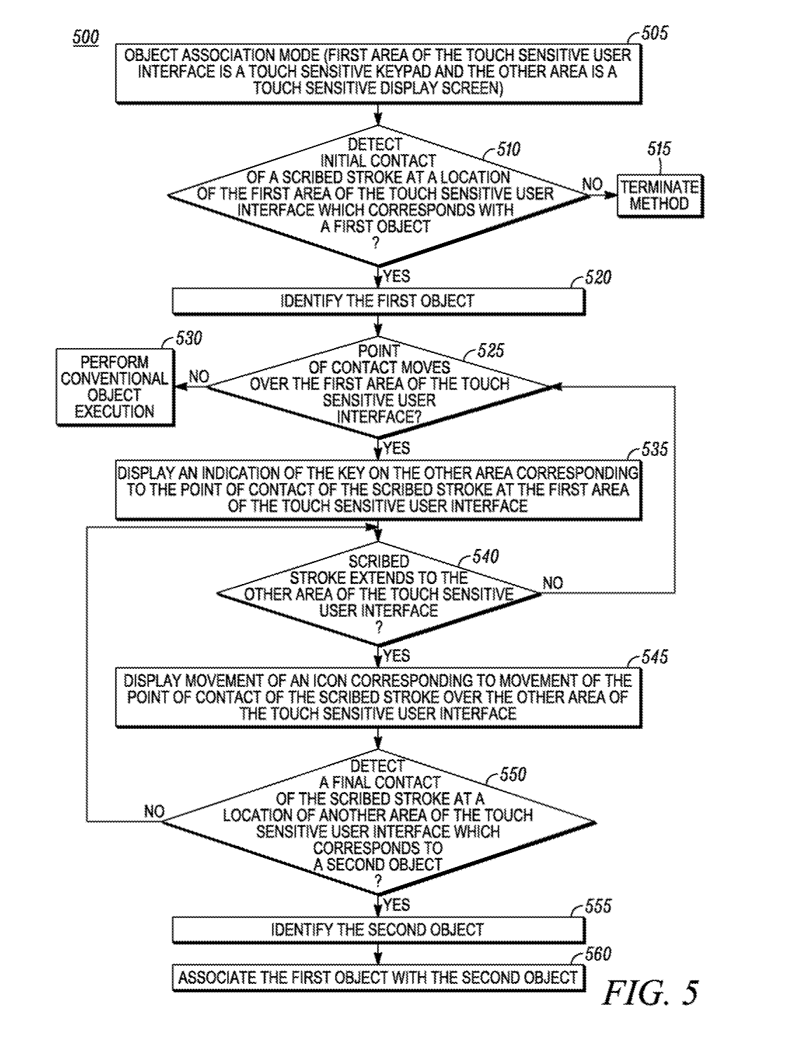

FIG. 5 illustrates a method of associating objects in an electronic device 100 in accordance with an alternative embodiment, in which an object is dragged from the keypad 165 to the screen 105. The method 500 is activated on the electronic device 100 by the user selecting an object association mode at step 505, for example by selecting a menu option. The method then attempts to detect an initial contact of a scribed stroke at a location of the first area of the touch sensitive user interface which corresponds with a first object at step 510. The first area of the touch sensitive user interface in this embodiment is the touch sensitive keypad 165 instead of the touch sensitive display screen 105. As previously described, the scribed stroke corresponds to the movement of the point of contact of a user's finger 310 or stylus across the first and second areas of the touch sensitive user interface 165 and 105. The location corresponding to the first object may be a key 265 as previously described; for example the send key FIG. 3A.

If no initial contact is detected (510N), for example after a predetermined time, then the method terminates at step 515. If however an initial contact is detected (510Y), then the first object is identified according to the location of the detected initial contact at step 520. This first object may be the contents of a temporary storage location associated with the send key 365, for example a contacts email address. In another example, the object may be an application such as Bluetooth™. The method 500 then determines whether the point of contact moves over the first area of the touch sensitive user interface (the keypad 165) at step 525. If not (525N), this means there is no scribed stroke, and in fact there is only stationary or temporary contact and the method then performs conventional object execution at step 530. For example if the send key is merely touched by the user's finger 310, then the Bluetooth™ application may be launched or executed and the method then terminates. If the object associated with the send key is content, then no action is taken. If however the point of contact moves (525Y), then the method displays on the display screen 105 an indication of the key on the touch sensitive keypad 165 corresponding to the point of contact of the scribed stroke at step 535. An example indication 330 is shown in FIG. 3B which displays both a label for the first object, in this case Bluetooth™, together with a label for the key 365, in this case Send.

The method 500 then determines whether the scribed stroke or point of contact extends or moves to the second area of the touch sensitive user interface (the display screen 105) at step 540. This may be implemented by detecting touch at any location on the display screen 105; or within a limited region of the display screen 105 adjacent the keypad 115 for example. If the scribed stroke doesn't extend onto the touch sensitive display screen 105 (540N), then the method returns to the step of determining whether movement of the point of contact or the scribed stroke moves over the touch sensitive display screen 105. If however the scribed stroke does extend onto the touch sensitive display screen 105 (540Y), then the method displays movement of an icon 320 corresponding to the first object and following movement of the point of contact of the scribed stroke over the display screen 105 at step 545. An example of this movement of the icon is shown in FIG. 3A by the partially drawn icon 325 following the user's finger across the display screen 105.

The method 500 then attempts to detect a final contact of the scribed stroke at a location of the second area of the touch sensitive user interface which corresponds to a second object at step 550. Unlike in the method 400 of FIG. 4, the second area of the touch sensitive user interface is the display screen 105 in this embodiment. Detecting a final contact may comprise detecting lift off of the finger 310 or stylus from the display screen 105, and if this is at an icon 320 which is associated with a second object (550Y), then the method identifies the second object at step 555. The second object (eg user application) is identified according to the location of the detected final contact which is typically indicated by an on-screen icon 320. If however a final contact is not detected after a predetermined time or a final contact is detected which does not correspond with a second object (550N), for example the final contact is between icons or is over an icon not assigned a second object, then the method 500 returns to determine whether the scribed stroke still extends over the second area of the touch sensitive user interface at step 540.

Once a second object has been identified at step 555, the method associates the first and second objects at step 560. As described previously, association of two objects can cover a variety of actions including copying or moving the content from one object to another, storing the content of the first object (in the second object—a temporary storage location), or providing a shortcut or other link from one object to another. Where one of the objects is an application, this may be automatically executed upon associating the first and second objects. For example a Bluetooth™ object may be started when associated with an email object in order to send the email over a Bluetooth™ connection.

Various example uses of the embodiments have already been described, including copying the contents of the first object into the second object, and optionally executing the second object in the same drag and drop user operation. This avoids the use of multiple menu selections which is time consuming and inconvenient for the user. This is one example of transferring objects. The embodiments may also be used to store objects, for example storing content or an application in a temporary storage location (second object). These stored objects may be persisted for example in non-volatile memory. This might allow for example a draft SMS message to be saved even after switching the device off, or to customise the device keys to perform a shortcut to an application.

The embodiment provides a number of advantages and functions. For example seamless drag and drop operations across the display and the keypad, as well as object storage through a drag and drop operation, from a mobile device display to its keypad. Object transfer through a drag and drop operation, from the mobile device keypad to its display. The ability to persist the object storage across mobile device power cycles and/or to quickly switch applications.

As mentioned described, due to the display size restriction, existing small device user interface designs do not support object drag & drop operations. Storing and using objects are usually done through on-screen menu which provides copy and paste functionality. However the embodiments take fewer steps to achieve the task. Instead of invoking menus and make selections, the embodiments use the convenient drag and drop method to perform the operation. They are also more flexible in terms of dropping objects as the device can give continuous user interface feedback when objects are being moved but before they are dropped. For example when a user is editing an MMS and wants to insert a picture, he can drag the picture object over the MMS text, and while moving the object, the MMS editor will layout the MMS contents dynamically and give instant preview of what happens if the image is inserted at the current location. This allows user to see the editing effects without committing the operation. Only if the user is satisfied with the preview, he will proceed to drop the object which completes the operation. This provides a seamless editing experience that cannot be achieved using menu-based operations.

In an embodiment the device can be configured such that the drag and drop operation from the display to the keypad effectively stores and assigns the (first) object to the destination key (second object). While the drag and drop operation from the keypad to the display effectively applies the stored (first) object to the dropped location (second object). As will be appreciated by those skilled in the art, the semantics of applying a stored object is application and object specific. For example, in the above scenario, applying the stored “Bluetooth” object to any screen may be configured to launch the Bluetooth™ application, and this serves as an easy way of customizing a shortcut key.

Further example dropping operations include: drop a contact to SMS screen to start editing a message to the person; drop a URL to a browser to navigate to the web page; drop a text fragment to any editor to paste the text.

Switching screens in mobile devices has always been troublesome. For example where a user is editing an SMS, and he then wants to copy some web contents to the message, he needs to launch the browser. The problem with known solutions is that after the browser is launched, the user has no quick way to go back to the SMS editing screen. The user can always close the browser screen, however this is typically sub-optimal and may not always be what the user wants. In an embodiment, the screen can be treated as another type of object. Prior to launching the browser, the user can drag the entire screen (through some designated area, such as the screen header) to a key. After launching the browser and copying the content, the user can drag the key into the display, effectively restoring the SMS edit screen.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

We claim:

1. A method of associating objects in an electronic device, the method comprising:
identifying a first object in response to detecting an initial contact of a scribed stroke at a location of a first area of a touch sensitive user interface which corresponds with the first object;
identifying a second object in response to detecting a final contact of the scribed stroke at a location of a second area of the touch sensitive user interface which corresponds with the second object; and
associating the first object with the second object,
wherein one of the first and second areas of the touch sensitive user interface is a touch sensitive display screen and the other area of the touch sensitive user interface is a touch sensitive keypad.

2. A method as claimed in claim 1, wherein the location of the first area of the touch sensitive user interface corresponding to the first object comprises an icon on the touch sensitive display screen, and the location of the second area of the touch sensitive user interface corresponding to the second object comprises a key on the touch sensitive keypad.

3. A method as claimed in claim 1, wherein the location of the first area of the touch sensitive user interface corresponding to the first object comprises a key on the touch sensitive tablet, and the location of the second area of the touch sensitive user interface corresponding to the second object comprises an icon on the touch sensitive display screen.

4. A method as claimed in claim 2, further comprising displaying on the touch sensitive display screen an indication of the key on the touch sensitive keypad corresponding to the point of contact in the scribed stroke at the touch sensitive keypad.

5. A method as claimed in claim 4, further comprising displaying on the touch sensitive display screen movement of the icon of a said object corresponding to movement of the point of contact of the scribed stroke at the touch sensitive display screen.

6. A method as claimed in claim 1, wherein associating the first object with the second object comprises copying content from the first object into the second object.

7. A method as claimed in claim 6, wherein the second object is a temporary storage location.

8. A method as claimed in claim 6, wherein the second object is an application which is automatically executed upon associating the first and second objects.

9. A method of associating objects in an electronic device, the method comprising:
identifying a first object in response to detecting an initial contact of a scribed stroke at a location of a first area of a touch sensitive display screen which corresponds with the first object; and
identifying a second object in response to detecting actuation of a key on a keypad which corresponds with the second object, said actuation of the key following termination of the scribed stroke on the touch sensitive display screen; and
associating the first object with the second object.

10. An electronic device comprising:
a touch sensitive user interface for receiving scribed strokes and having a first area and a second area;
a processor arranged to identify a first object in response to detecting an initial contact of the scribed stroke at a location of the first area of the touch sensitive user interface corresponding to the first object, identify a second object in response to detecting a final contact of the scribed stroke at a location of the second area of the touch sensitive user interface corresponding to the second object, and associate the first object with the second object,
wherein one of the first and second areas of the touch sensitive user interface is a touch sensitive display screen and the other area of the touch sensitive user interface is a touch sensitive keypad.

11. An electronic device as claimed in claim 10, wherein the touch sensitive display screen is arranged to display an icon at the location of the first area of the touch sensitive user interface corresponding to the first object, and wherein the location of the second area of the touch sensitive user interface corresponding to the second object comprises a key on the touch sensitive keypad.

12. An electronic device as claimed in claim 10, wherein the touch sensitive display screen is arranged to display an icon at the location of the first area of the touch sensitive user interface corresponding to the second object, and wherein the location of the second area of the touch sensitive user interface corresponding to the first object comprises a key on the touch sensitive keypad.

13. An electronic device as claimed in claim 10, wherein the touch sensitive display screen is arranged to display an indication of the key on the touch sensitive keypad corresponding to the point of contact in the scribed stroke at the touch sensitive keypad.

14. An electronic device as claimed in claim 13, wherein the touch sensitive display screen is arranged to display movement of the icon of a said object corresponding to movement of the point of contact of the scribed stroke at the touch sensitive display screen.

15. An electronic device as claimed in claim 10, wherein associating the first object with the second object comprises copying content from the first object into the second object.

16. An electronic device as claimed in claim 15, wherein the second object is a temporary storage location.

17. An electronic device as claimed in claim 10, wherein the second object is an application which is automatically executed upon associating the first and second objects.
